(19) United States
(12) Patent Application Publication
(10) Pub. No.: US 2010/0239059 A1
(43) Pub. Date: Sep. 23, 2010

(54) TRANSMISSION METHOD AND TRANSMISSION APPARATUS

(75) Inventors: Hirokazu Sugimoto, Osaka (JP); Toru Iwata, Osaka (JP)

Correspondence Address: McDERMOTT WILL & EMERY LLP, 600 13th Street, N.W., Washington, DC, 20005-3096, US

(73) Assignee: PANASONIC CORPODRATION, Osaka (JP)

(21) Appl. No.: 12/790,274

(22) Filed: May 28, 2010

Related U.S. Application Data
(63) Continuation of application No. PCT/JP2008/002476, filed on Sep. 8, 2008.

(30) Foreign Application Priority Data
Nov. 30, 2007 (JP) 2007-310806

(51) Int. Cl. H04L 7/00

(52) U.S. Cl. 375/371

(57) ABSTRACT

A data transmission circuit transmits transmission data to a receiving apparatus. The clock transmission circuit transmits a transmission clock to the receiving apparatus when the transmission data is transmitted by the data transmission circuit. The phase control circuit varies a phase of the transmission clock to a phase different from that of the transmission data after the transmission clock is transmitted from the clock transmission circuit.

### CROSS-REFERENCE TO RELATED APPLICATION

This is a continuation of PCT International Application PCT/JP2008/002476 filed on Sep. 8, 2008, which claims priority to Japanese Patent Application No. 2007-310806 filed on Nov. 30, 2007. The disclosures of these applications including the specifications, the drawings, and the claims are hereby incorporated by reference in their entirety.

### BACKGROUND

A technique disclosed in this specification relates to a method and an apparatus for transmitting data and a clock.

In recent years, as the amount of information of a digital signal increases, a parallel transmission scheme is changed to a serial transmission scheme, and a data rate (transmission speed) is changed from several hundred Mbps to several Gbps (DVI (Digital Visual Interface) and HDMI (High Definition Multimedia Interface) for example). As the transmission becomes faster, timing margins permitted for transmitting and receiving operations become severer. Especially when a transmission signal from a transmission apparatus passes through a wiring on a board or a transmission cable, since influence (noise) from outside is superimposed on the transmission signal, it is necessary for a receiving apparatus to adjust a phase relation between transmission data and a latch clock (acquisition timing of the transmission data) to precisely receive the transmission data from the transmission apparatus.

FIG. 9 shows an example of a configuration of conventional transmission apparatus and receiving apparatus. Here, an example in which parallel data Din [1:k] of k bits (k is an integer of 2 or greater) is transmitted will be described. Although one set of transmission data Dout is transmitted with respect to one transmission clock CKout in FIG. 9, multiple sets of transmission data may be transmitted. For example, in the DVI or HDMI, three sets of transmission data (serial data of 10 bits) are transmitted together with one transmission clock.

A transmission apparatus 91 multiplies a frequency of an input clock CKin by k to produce an internal clock, converts the parallel data Din [1:k] into serial data of k bits based on the internal clock, and transmits the same as transmission data Dout. The transmission apparatus 91 divides a frequency of the internal clock by k, and transmits the same as the transmission clock CKout. The transmission data Dout and the transmission clock CKout from the transmission apparatus 91 are transmitted to the receiving apparatus 92 through a transmission channel 90.

The receiving apparatus 92 includes a phase adjusting circuit 901 and a serial/parallel converting circuit 902. The phase adjusting circuit 901 adjusts phases of k latch clocks LCK, LCK, . . . based on the transmission data Dout and the transmission clock CKout from the transmission channel 90. The serial/parallel converting circuit 902 is constituted by k flip-flops FF9, FF9, . . . for example, and takes in the transmission data Dout in synchronization with the k latch clocks LCK, LCK, . . . from the phase adjusting circuit 901. With this, the transmission data Dout is taken into the receiving apparatus 92 as parallel data.

FIG. 10 shows an example of an internal configuration of the phase adjusting circuit 901 shown in FIG. 9. The phase adjusting circuit 901 includes a PLL circuit 910, a delay adjusting circuit 911, a multiphase clock producing circuit 912, k phase comparing circuits 913, 913, . . . , a delay control circuit 914, and a selecting circuit 915.

The PLL circuit 910 multiplies the frequency of the transmission clock CKout by k, and outputs the same as a reference clock CKa. The delay adjusting circuit 911 delays the reference clock CKa from the PLL circuit 910 in accordance with control voltage VC.

The multiphase clock producing circuit 912 produces (k×j) (j is an integer equal to or greater than 1) delay clocks CKb, CKb, . . . based on the reference clock CKa delayed by the delay adjusting circuit 911. The (k×j) delay clocks CKb, CKb, . . . have frequencies that are 1/k of the reference clock CKa, and phases thereof are deviated by (2π/(k×j)) from each other.

Each of the phase comparing circuits 913, 913, . . . compare phases of j delay clocks CKb, CKb, . . . produced by the multiphase clock producing circuit 912 and a phase of the transmission data Dout with each other. When each of the phase comparing circuits 913, 913, . . . carry out over sampling of three times with respect to the transmission data Dout as described in Japanese Patent Publication No. 2003-218843 for example, each of the phase comparing circuits 913, 913, . . . carry out the over sampling using three delay clocks CKb, CKb, and CKb having phases that are deviated from one another by (2π/3k).

The delay control circuit 914 increases or decreases a control voltage VC for controlling a delay amount in the delay adjusting circuit 911 based on comparison results obtained by each of the phase comparing circuits 913, 913, . . . .

The selecting circuit 915 selects latch clocks LCK, LCK, . . . from the delay clocks CKb, CKb, . . . produced by the multiphase clock producing circuit 912 based on the comparison results obtained by each of the phase comparing circuits 913, 913, . . . .

The phase adjusting operation is carried out in the above-described manner.

FIG. 11 shows a corresponding relation between the control voltage VC and the phase of the delay clock CKb. As the voltage value of the control voltage VC is greater, the deviation amount of the phase of the delay clock CKb with respect to the variation amount of the control voltage VC becomes smaller as shown in FIG. 11. When the control voltage VC becomes greater by a voltage amount Vm for example, the phase deviation amount Tb of the delay clock CKb in a state Pb is smaller than a phase deviation amount Ta of the delay clock CKb in a state Pa. That is, the state Pb can be said to have higher tolerance (stable state) to jitter of the control voltage VC than the state Pa.

### SUMMARY

In the receiving apparatus, however, it is not always true that the phase of the delay clock CKb is locked always in its stable state. If the phase of the delay clock CKb is locked in a state where the deviation amount of the phase of the delay clock CKb with respect to variation of the control voltage VC is large (unstable state: state Pa in FIG. 11 for example), the phase of the delay clock CKb is considerably varied due to jitter of the control voltage VC. Therefore, set up/hold time of the flip-flop cannot sufficiently be secured in the serial/parallel converting circuit, and the transmission data Dout cannot be taken in precisely.

Hence, it is an object of the technique disclosed in this specification to enhance the possibility that the phase of the delay clock is locked in a state where the deviation amount of the phase of the delay clock with respect to variation in control voltage is small (stable state).

According to one aspect of the present invention, there is provided a transmission method for transmitting data and a clock from a transmission apparatus to a receiving apparatus, in which the receiving apparatus includes: a clock producing circuit that produces a delay clock based on a received clock and that can change a delay amount of a phase of the delay clock by a control voltage; a phase comparing circuit that compares a phase of received data and a phase of the delay clock produced by the clock producing circuit with each other; and a delay control circuit that increases or decreases the control voltage based on a comparison result of the phase comparing circuit, where the transmission apparatus includes: a data transmission circuit configured to transmit transmission data to the receiving apparatus; a clock transmission circuit configured to transmit a transmission clock to the receiving apparatus when the transmission data is transmitted by the data transmission circuit, and that can adjust a phase of the transmission clock; and a phase control circuit configured to vary the phase of the transmission clock to a phase different from that of the transmission data after the transmission clock is transmitted from the clock transmission circuit, the clock transmission circuit includes: a delay element configured to output the transmission clock; and a variable current source configured to supply current to the delay element, and the transmission method including the steps of: (a) transmitting the transmission data to the receiving apparatus; (b) transmitting the transmission clock to the receiving apparatus; and (c) varying the phase of the transmission clock transmitted in the step (b) to a phase different from that of the transmission data by adjusting a current amount of the variable current source by the phase control circuit.

According to the transmission method, the phase adjusting operation can be carried out again in the receiving apparatus by varying the phase of the transmission clock, and it is capable of enhancing the possibility that the phase of the delay clock is locked in a stable state (a state where a deviation amount of the phase of the delay clock with respect to variation of control voltage is small). With this, the tolerance of the receiving apparatus to jitter can be enhanced, and communication errors caused by erroneous latch of transmission data in the receiving apparatus can be reduced.

The transmission method may further include the step of (d) further varying the phase of the transmission clock after the phase of the transmission clock is varied in the step (c).

In the transmission method, if the phase of the transmission clock is varied a plurality of times, the possibility that the phase of the delay clock is locked in the stable state can further be enhanced.

According to another aspect of the invention, there is provided a transmission apparatus that transmits data and a clock to a receiving apparatus, in which the receiving apparatus includes: a clock producing circuit that produces a delay clock based on a received clock and that can change a delay amount of a phase of the delay clock by a control voltage; a phase comparing circuit that compares a phase of received data and a phase of the delay clock produced by the clock producing circuit with each other; and a delay control circuit that increases or decreases the control voltage based on a comparison result of the phase comparing circuit, the transmission apparatus including: a data transmission circuit configured to transmit transmission data to the receiving apparatus; a clock transmission circuit configured to transmit a transmission clock to the receiving apparatus when the transmission data is transmitted by the data transmission circuit, and that can adjust a phase of the transmission clock; and a phase control circuit configured to vary the phase of the transmission clock to a value different from that of the transmission data after the transmission clock is transmitted from the clock transmission circuit, wherein the clock transmission circuit includes: a delay element configured to output the transmission clock, and a variable current source configured to supply current to the delay element, and the phase control circuit varies a phase of the transmission clock by adjusting a current amount of the variable current source.

According to the transmission apparatus, it is capable of enhancing the possibility that the phase of the delay clock is locked in the stable state (the state where the deviation amount of the phase of the delay clock with respect to variation of control voltage is small).

According to another aspect of the invention, there is provided a transmission apparatus that transmits data and a clock to a receiving apparatus, in which the receiving apparatus includes: a clock producing circuit that produces a delay clock based on a received clock and that can change a delay amount of a phase of the delay clock by a control voltage; a phase comparing circuit that compares a phase of received data and a phase of the delay clock produced by the clock producing circuit with each other; and a delay control circuit that increases or decreases the control voltage based on a comparison result of the phase comparing circuit, the transmission apparatus including: a data transmission circuit configured to transmit transmission data to the receiving apparatus; a clock transmission circuit configured to transmit a transmission clock to the receiving apparatus when the transmission data is transmitted by the data transmission circuit, and that can adjust a phase of the transmission clock; and a phase control circuit configured to vary the phase of the transmission clock to a phase different from that of the transmission data at a predetermined time interval after the transmission clock is transmitted from the clock transmission circuit.

According to the transmission apparatus, it is capable of enhancing the possibility that the phase of the delay clock is locked in the stable state (the state where the deviation amount of the phase of the delay clock with respect to variation of control voltage is small).

The phase control circuit may vary the phase of the transmission clock a plurality of times.

The predetermined time interval may be determined in accordance with a variable width of a delay amount of the phase of the delay clock in the receiving apparatus.

The phase control circuit may vary the phase of the transmission clock based on a standard of an input clock of the transmission apparatus.

### BRIEF DESCRIPTION OF THE DRAWINGS

FIG. 1 is a block diagram showing an example of a configuration of a transmission apparatus;

FIG. 2 is an explanatory diagram of phases of delay clocks produced by a phase converting circuit shown in FIG. 1;

FIG. 3 is an explanatory diagram of operation carried out by the transmission apparatus shown in FIG. 1;

FIG. 4 is an explanatory diagram of a modification of operation carried out by the transmission apparatus shown in FIG. 1;

FIG. 5 is an explanatory diagram of another modification of operation carried out by the transmission apparatus shown in FIG. 1;

FIG. 6 is an explanatory diagram of another modification of operation carried out by the transmission apparatus shown in FIG. 1;

FIG. 7 is a diagram showing a modification of a phase changing circuit shown in FIG. 1;

FIG. 8 is an explanatory diagram of operation of a transmission apparatus having the phase changing circuit shown in FIG. 7;

FIG. 9 is a block diagram showing an example of a configuration of conventional transmission apparatus and receiving apparatus;

FIG. 10 is a block diagram showing an example of an internal configuration of a phase adjusting circuit shown in FIG. 9; and

FIG. 11 is an explanatory graph of a relation between a control voltage and a phase of a clock in the receiving apparatus.

### DETAILED DESCRIPTION

An embodiment will be described in detail with reference to the drawings. The same or corresponding portions in the drawings are designated with the same symbols, and explanation thereof is not repeated.

[Configuration of Transmission Apparatus]

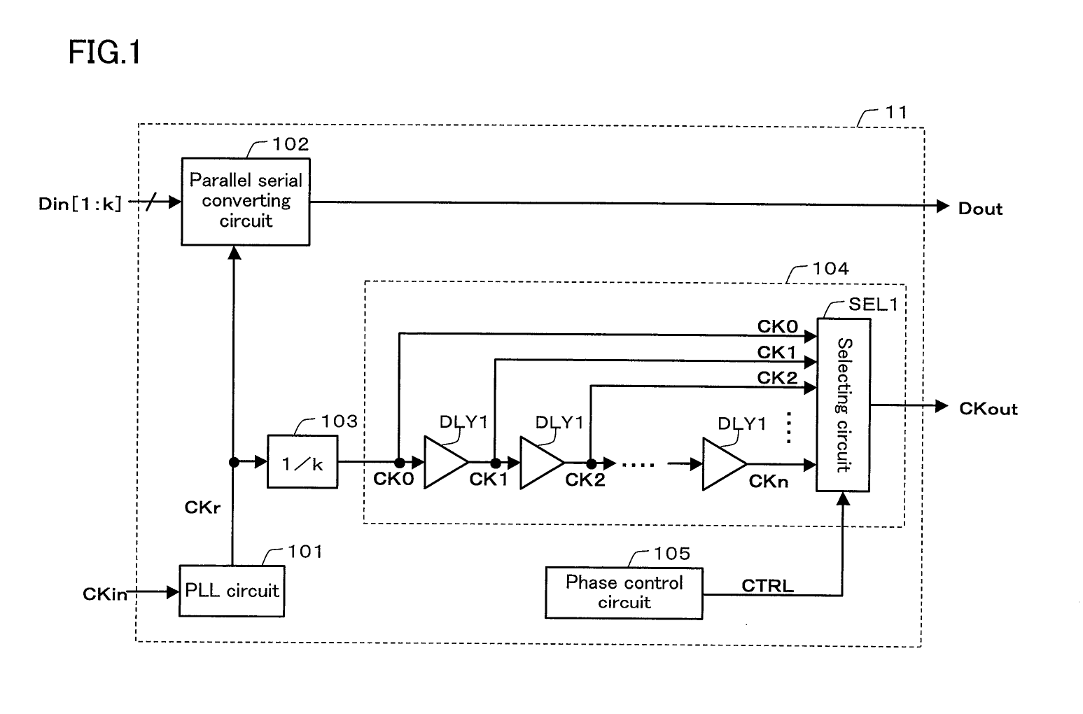

FIG. 1 shows an example of a configuration of the transmission apparatus. The transmission apparatus 11 includes a PLL circuit 101, a parallel serial converting circuit 102 (data transmission circuit), a frequency dividing circuit 103, a phase changing circuit 104 (clock transmission circuit), and a phase control circuit 105. The transmission apparatus 11 converts k bits (k is an integer equal to or greater than 2) parallel data Din [1: k] into k bits serial data, and transmits the same as transmission data Dout, and transmits the transmission clock CKout based on an input clock CKin having a predetermined frequency.

The PLL circuit 101 multiplies the frequency of the input clock CKin by k, and outputs the same as the internal clock CKr.

The parallel serial converting circuit 102 converts the k bits parallel data Din [1: k] into k bits serial data in synchronization with the internal clock CKr from the PLL circuit 101, and transmits the same as the transmission data Dout.

The frequency dividing circuit 103 divides a frequency of the internal clock CKr from the PLL circuit 101 by k, and outputs the same as a frequency dividing clock CK0.

The phase changing circuit 104 receives the frequency dividing clock CK0 from the frequency dividing circuit 103, and transmits the transmission clock CKout. The phase changing circuit 104 can adjust a phase of the transmission clock CKout. For example, the phase changing circuit 104 includes serially connected n delay elements DLY1, DLY1, . . . , and a selecting circuit SEL1. The selecting circuit SEL1 selects and outputs one of frequency dividing clock CK0, and outputs CK1, CK2, . . . CKn of the delay elements DLY1, DLY1, . . . in response to control carried out by the phase control circuit 105.

The phase control circuit 105 controls a phase of the transmission clock CKout that is output from the phase changing circuit 104.

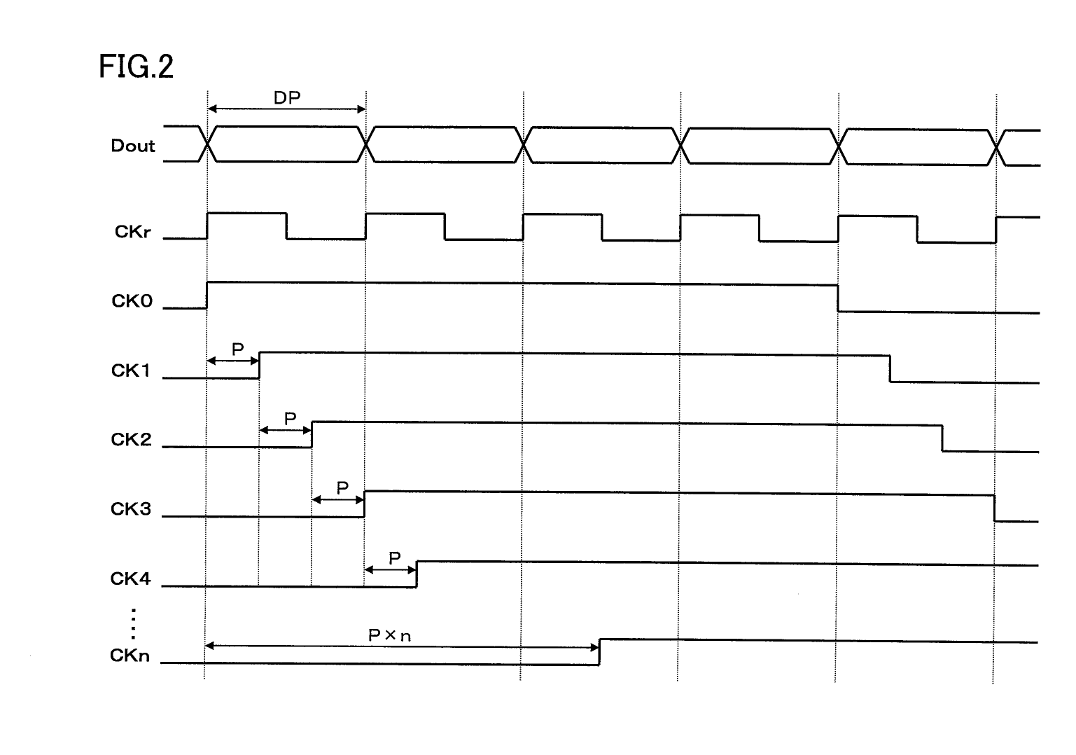

It is assumed that a delay amount of each of the delay elements DLY1, DLY1, . . . is “P”, and phases of the frequency dividing clock CK0 and the delay clocks CK1, CK2, . . . CKn are deviated from each other by “P” as shown in FIG. 2. The delay amounts of the delay elements DLY1, DLY1, . . . may be different from each other. A difference in phase between the delay clock CK (X) and a clock signal CK (X+3) is a phase amount “DP” corresponding to one bit width of the transmission data Dout (here, 1≦X≦n−3).

[Configuration of Receiving Apparatus]

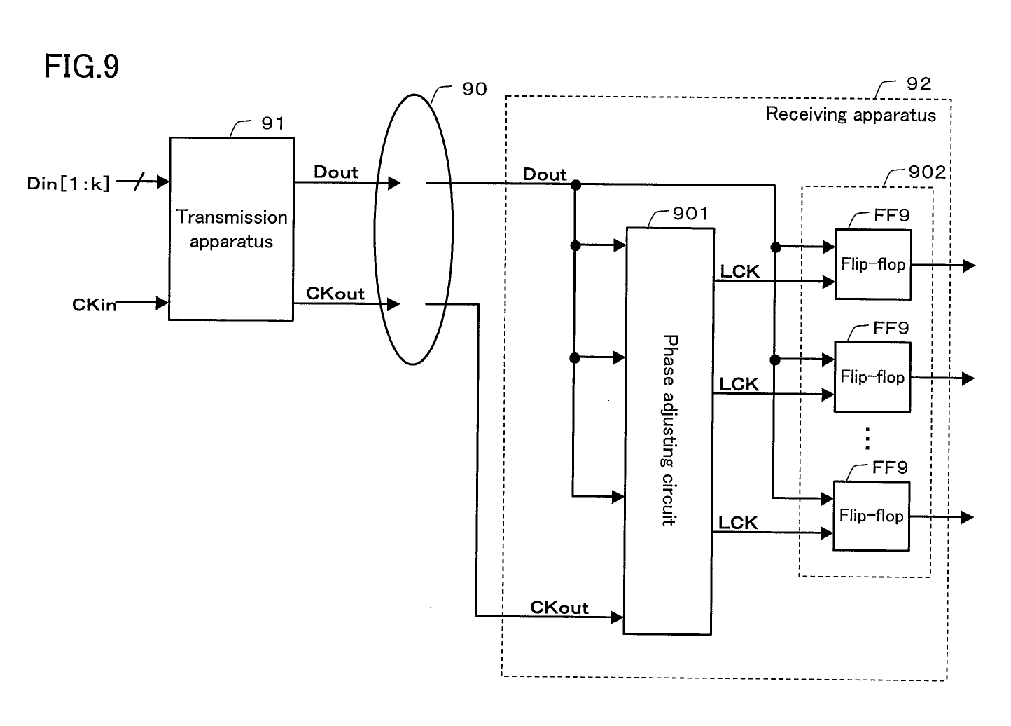

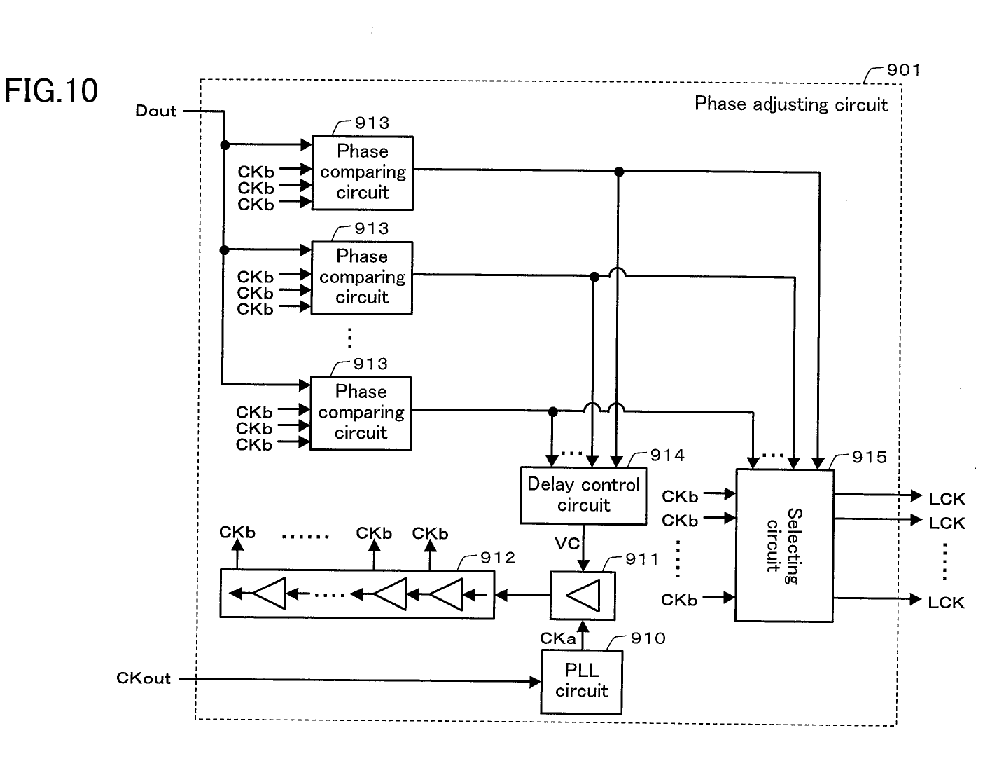

The receiving apparatus to which data and a clock are sent has the same configuration as that shown in FIGS. 9 and 10. The receiving apparatus includes a clock producing circuit (e.g., the PLL circuit 910, the delay adjusting circuit 911, and the multiphase clock producing circuit 912), a phase comparing circuit (e.g., the phase comparing circuits 913, 913, . . . ), and a delay control circuit (e.g., the delay control circuit 914). The clock producing circuit produces one or more delay clocks based on a received clock. A delay amount of phase of a delay clock produced by the clock producing circuit can be adjusted by a control voltage. The phase comparing circuit compares a phase of received data and a phase of a delay clock with each other. The delay control circuit increases or decreases the control voltage based on a comparison result of the phase comparing circuit. The receiving apparatus may include a selecting circuit 915 and a serial/parallel converting circuit 902 to take in the transmission data Dout as parallel data.

[Operation Performed by Transmission Apparatus]

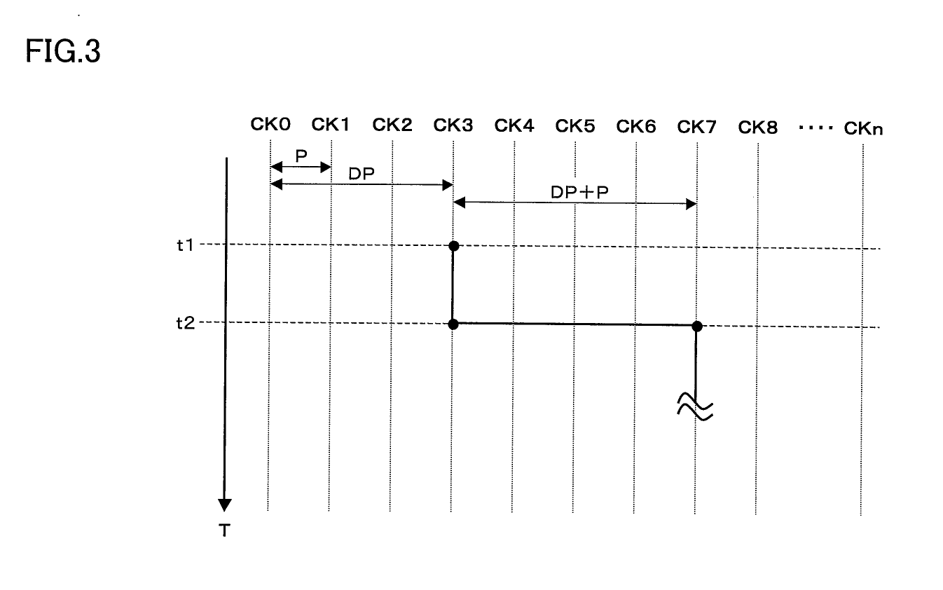

Next, the operation performed by the transmission apparatus shown in FIG. 1 will be described with reference FIG. 3. To simplify the explanation, it is assumed that the receiving apparatus has the configuration shown in FIGS. 9 and 10.

At time t1, parallel data Din [1: k] and an input clock CKin are supplied to the transmission apparatus 11. The PLL circuit 101 outputs an internal clock CKr based on the input clock CKin. The parallel serial converting circuit 102 converts the parallel data Din [1: k] into serial data and transmits the same as the transmission data Dout. The frequency dividing circuit 103 divides a frequency of the internal clock CKr, and outputs a frequency dividing clock CK0 to the phase changing circuit 104. At that time, the phase control circuit 105 controls the selecting circuit SEL1 such that the delay clock CK3 is selected (i.e., the delay clock CK3 is transmitted from the phase changing circuit 104 as the transmission clock CKout). The transmission data Dout and the transmission clock CKout (delay clock CK3) are transmitted to the receiving apparatus 92 in this manner. In the receiving apparatus 92, the PLL circuit outputs a reference clock CKa based on the transmission clock CKout from the transmission apparatus 11, the delay adjusting circuit 911 delays the reference clock CKa from the PLL circuit 910 in accordance with the control voltage VC, and supplies the same to the multiphase clock producing circuit 912. The receiving apparatus 92 carries out the phase adjusting operation based on the transmission clock CKout that is the delay clock CK3.

Next, at time t2, the phase control circuit 105 controls the selecting circuit SEL1 such that a delay clock CK7 having a phase that is more delayed than the delay clock CK3 by “DP+P” is selected (i.e., the delay clock CK7 having a delay amount of phase with respect to the delay clock CK3 greater than a phase amount corresponding to one bit width is transmitted as the transmission clock CKout). With this, the receiving apparatus 92 carries out the phase adjusting operation again based on the transmission clock CKout that is the delay clock CK7. A time period between time t1 and time t2 may have such a length that the phase adjusting operation is carried out by the receiving apparatus 92.

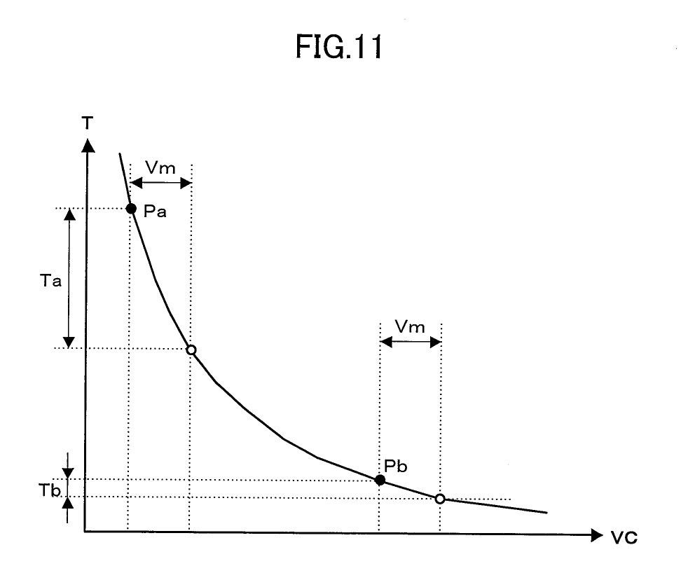

By varying the phase of the transmission clock CKout as described above, the phase adjusting operation can be carried out again in the receiving apparatus, and it is capable of enhancing the possibility that the phase of the delay clock CKb is locked in a stable state (state where the deviation amount of the phase of the delay clock CKb with respect to the variation in control voltage VC is small: state Pb in FIG. 11 for example). With this, the tolerance of the receiving apparatus to the jitter can be enhanced, and communication errors caused by erroneous latch of transmission data in the receiving apparatus can be reduced.

[Variation Amount of Phase]

A variation amount of phase of the transmission clock CKout at time t2 may be smaller than one bit width of the transmission data Dout. That is, if the phase of the transmission clock CKout is varied to a value different from the transmission data Dout at time t2, the phase adjusting operation can be performed again in the receiving apparatus 92.

[The Number of Times of Variation of Phase]

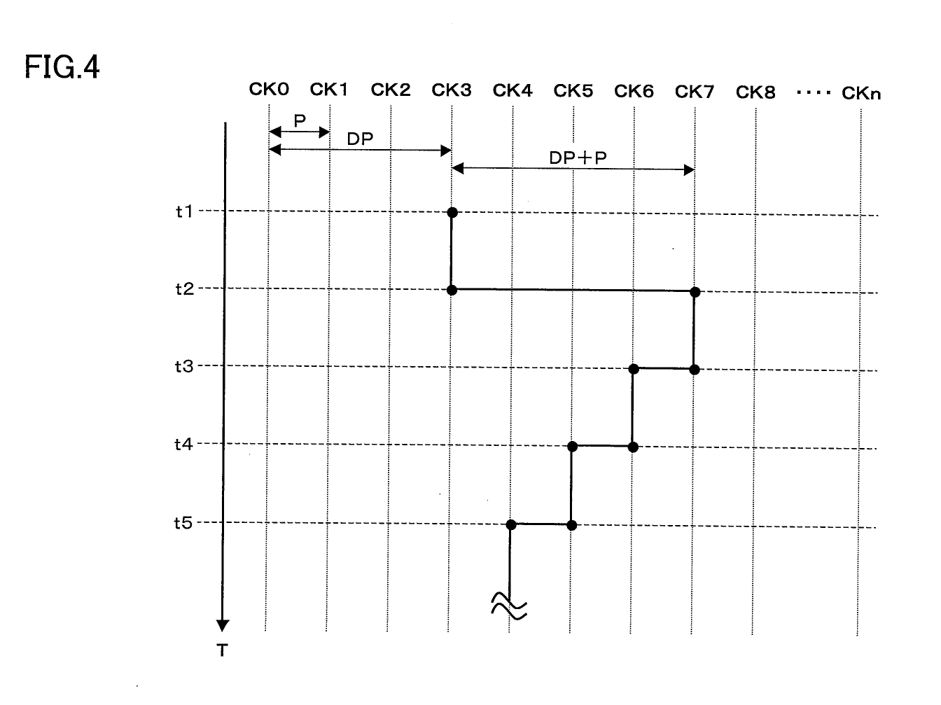

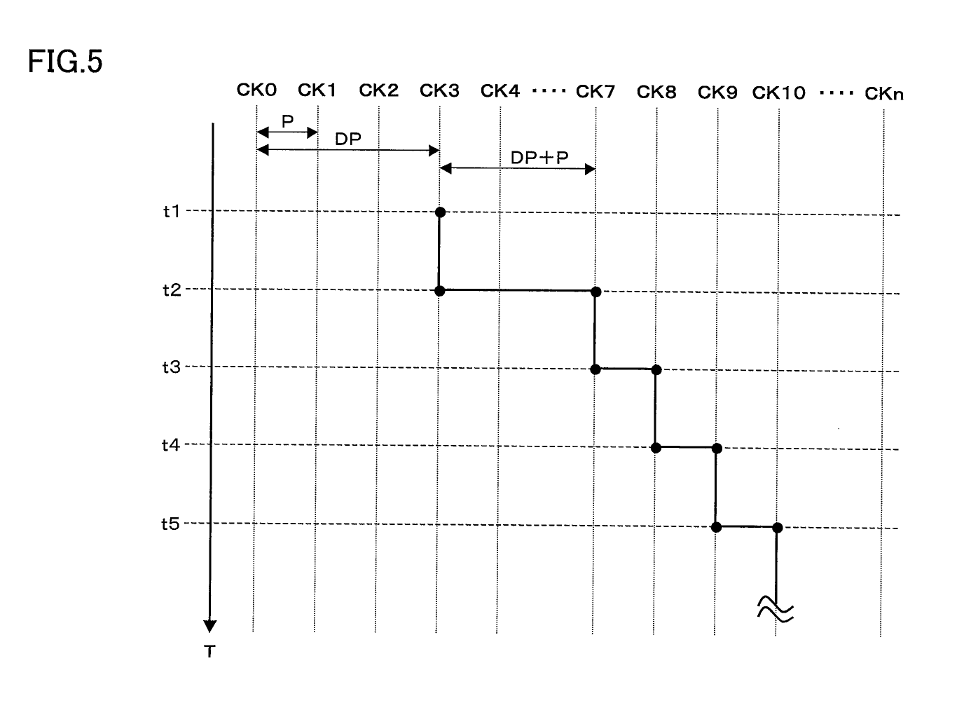

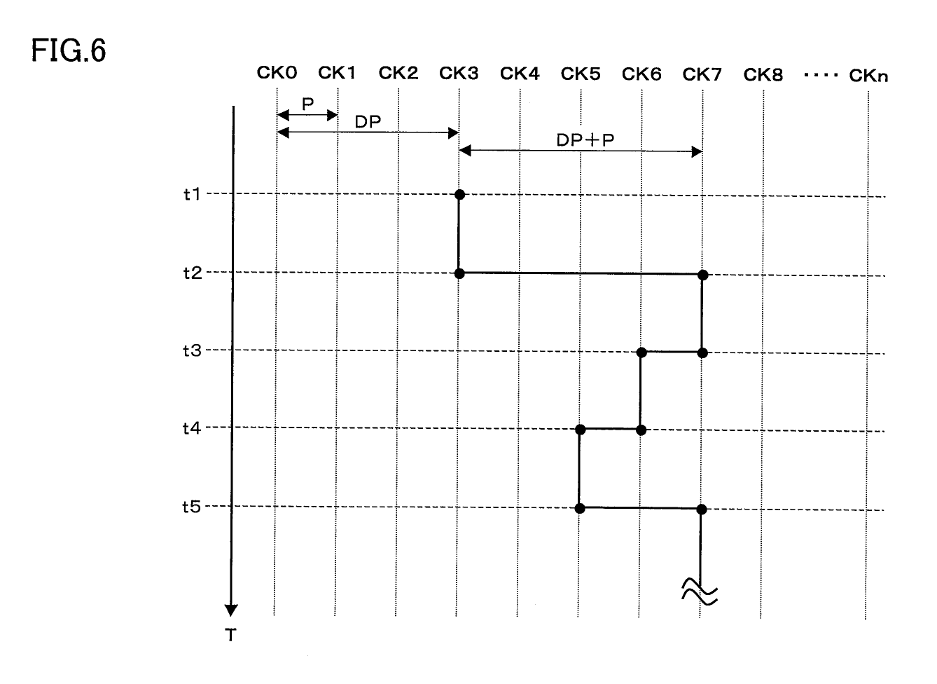

The phase of the transmission clock CKout may be varied after the phase of the transmission clock CKout is varied at time t2 as shown in FIGS. 4, 5 and 6. For example, in FIG. 4, the phase of the transmission clock CKout advances in stages by the phase amount “P” with time t3, t4 and t5. In FIG. 5, the phase delays by the phase amount “P” in stages. In FIG. 6, the phase advances in stages by the phase amount “P” and then, the phase of the transmission clock CKout delays by the phase amount “2P” at time t5. The phase may delay in stages by the phase amount “P” and then, the phase of the transmission clock CKout may advance on the contrary. By varying the phase of the transmission Clock CKout at a plurality of times in this manner, it is capable of further enhancing the possibility that the receiving apparatus 92 is stabilized.

[Determination of the Variation Amount of Phase and the Number of Times of Variation of Phase]

The variation amount and the number of times of variation of the phase of the transmission clock CKout may be determined based on a frequency of the input clock CKin. For example, the phase control circuit 105 may determine the variation amount and the number of times of variation of the phase of the transmission clock CKout based on the frequency information of the PLL circuit 101 (such as voltage value of a low-pass filter). Since the frequency of the transmission clock CKout is determined in the DVI and HDMI, the phase control circuit 105 may determine the variation amount and the number of times of variation of the phase of the transmission clock CKout based on the transmission standard.

[State of Variation of Phase]

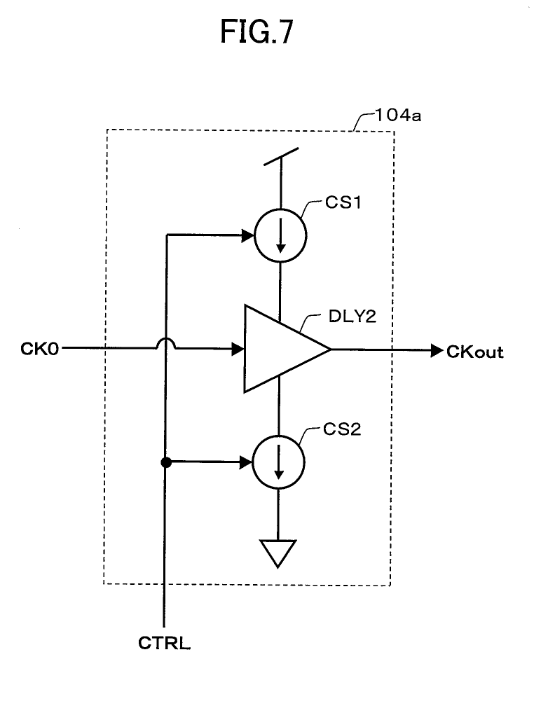

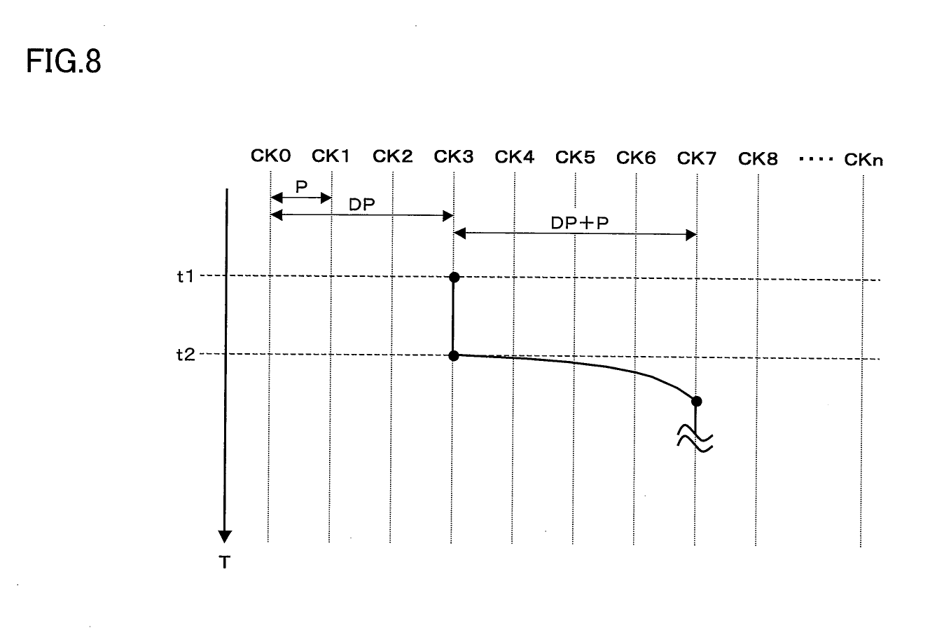

The transmission clock CKout may be varied continuously instead of stepwise. For example, the transmission apparatus 11 may include a phase changing circuit 104a shown in FIG. 7 instead of the phase changing circuit 104 shown in FIG. 1. The phase changing circuit 104a includes a delay element DLY2 and variable current sources CS1 and CS2. The delay element DLY2 receives a frequency dividing clock CK0 from the frequency dividing circuit 103, and outputs a transmission clock CKout. The variable current sources CS1 and CS2 supply current to the delay element DLY2. The phase control circuit 105 adjust the amount of current of the variable current sources CS1 and CS2. As the amount of current of the variable current sources CS1 and CS2 increases, the delay amount of the delay element DLY2 decreases. The variable current sources CS1 and CS2 gradually vary the current amount in response to the control performed by the phase control circuit 105. As a result, the delay amount in the delay element DLY2 is gradually varied, and the phase of the transmission clock CKout is continuously varied as shown in FIG. 8.

According to the transmission method and the transmission apparatus, it is capable of enhancing the possibility that the delay clock is locked in a stable state in the receiving apparatus as described above.

The above-described embodiment is a preferred example, and it is not intended that the present invention is applied to the embodiment and a scope of usage is limited thereto.

What is claimed is:

1. A transmission method for transmitting data and a clock from a transmission apparatus to a receiving apparatus, in which the receiving apparatus includes: a clock producing circuit that produces a delay clock based on a received clock and that can change a delay amount of a phase of the delay clock by a control voltage; a phase comparing circuit that compares a phase of received data and a phase of the delay clock produced by the clock producing circuit with each other; and a delay control circuit that increases or decreases the control voltage based on a comparison result of the phase comparing circuit, where
the transmission apparatus includes:
a data transmission circuit configured to transmit transmission data to the receiving apparatus;
a clock transmission circuit configured to transmit a transmission clock to the receiving apparatus when the transmission data is transmitted by the data transmission circuit, and that can adjust a phase of the transmission clock; and
a phase control circuit configured to vary the phase of the transmission clock to a phase different from that of the transmission data after the transmission clock is transmitted from the clock transmission circuit,
the clock transmission circuit includes:
a delay element configured to output the transmission clock; and
a variable current source configured to supply current to the delay element, and
the transmission method comprising the steps of:
(a) transmitting the transmission data to the receiving apparatus;
(b) transmitting the transmission clock to the receiving apparatus; and
(c) varying the phase of the transmission clock transmitted in the step (b) to a phase different from that of the transmission data by adjusting a current amount of the variable current source by the phase control circuit.

2. The transmission method of claim 1, further comprising the step of:
(d) further varying the phase of the transmission clock after the phase of the transmission clock is varied in the step (c).

3. The transmission method of claim 2, wherein
the transmission clock is produced based on an input clock having a predetermined frequency, and
the phase of the transmission clock is varied based on the frequency of the input clock.

4. A transmission apparatus that transmits data and a clock to a receiving apparatus, in which the receiving apparatus includes: a clock producing circuit that produces a delay clock based on a received clock and that can change a delay amount of a phase of the delay clock by a control voltage; a phase comparing circuit that compares a phase of received data and a phase of the delay clock produced by the clock producing circuit with each other; and a delay control circuit that increases or decreases the control voltage based on a comparison result of the phase comparing circuit, the transmission apparatus comprising:
a data transmission circuit configured to transmit transmission data to the receiving apparatus;
a clock transmission circuit configured to transmit a transmission clock to the receiving apparatus when the transmission data is transmitted by the data transmission circuit, and that can adjust a phase of the transmission clock; and
a phase control circuit configured to vary the phase of the transmission clock to a value different from that of the transmission data after the transmission clock is transmitted from the clock transmission circuit, wherein
the clock transmission circuit includes:
a delay element configured to output the transmission clock, and
a variable current source configured to supply current to the delay element, and
the phase control circuit varies a phase of the transmission clock by adjusting a current amount of the variable current source.

5. The transmission apparatus of claim 4, wherein
the phase control circuit varies the phase of the transmission clock a plurality of times.

6. The transmission apparatus of claim 4, wherein
the clock transmission circuit produces the transmission clock based on an input clock having a predetermined frequency, and
the phase control circuit varies the phase of the transmission clock based on the frequency of the input clock.

7. A transmission apparatus that transmits data and a clock to a receiving apparatus, in which the receiving apparatus includes: a clock producing circuit that produces a delay clock based on a received clock and that can change a delay amount of a phase of the delay clock by a control voltage; a phase comparing circuit that compares a phase of received data and a phase of the delay clock produced by the clock producing circuit with each other; and a delay control circuit that increases or decreases the control voltage based on a comparison result of the phase comparing circuit, the transmission apparatus comprising:
a data transmission circuit configured to transmit transmission data to the receiving apparatus;
a clock transmission circuit configured to transmit a transmission clock to the receiving apparatus when the transmission data is transmitted by the data transmission circuit, and that can adjust a phase of the transmission clock; and
a phase control circuit configured to vary the phase of the transmission clock to a phase different from that of the transmission data at a predetermined time interval after the transmission clock is transmitted from the clock transmission circuit.

8. The transmission apparatus of claim 7, wherein
the phase control circuit varies the phase of the transmission clock a plurality of times.

9. The transmission apparatus of claim 7, wherein
the predetermined time interval is determined in accordance with a variable width of a delay amount of the phase of the delay clock in the receiving apparatus.

10. The transmission apparatus of claim 7, wherein
the phase control circuit varies the phase of the transmission clock based on a standard of an input clock of the transmission apparatus.
